(19) United States
(12) Patent Application Publication
(10) Pub. No.: US 2015/0109622 A1
(43) Pub. Date: Apr. 23, 2015

(54) OPTICAL COHERENCE TOMOGRAPHY APPARATUS AND OPTICAL COHERENCE TOMOGRAPHY METHOD

(71) Applicant: CANON KABUSHIKI KAISHA, Tokyo (JP)

(72) Inventor: Takefumi Ota, Nagareyama-shi (JP)

(21) Appl. No.: 14/390,327

(22) PCT Filed: Apr. 1, 2013
(86) PCT No.: PCT/JP2013/060567

§ 371 Date: Oct. 2, 2014

(30) Foreign Application Priority Data
Apr. 5, 2012 (JP) 2012-086533

(51) Int. Cl. G01B 9/02

(52) U.S. Cl. CPC G01B 9/02084; G01B 9/02004; G01B 9/02091
USPC 356/479

(57) ABSTRACT

An optical coherence tomography apparatus includes a light source unit that emits light including lights emitted from swept sources, which have different center wavelengths and partially overlapping output spectral ranges, the lights having the respective output spectral ranges and being temporally separated from each other, a dividing unit that is connected to the light source unit and that divides the light emitted from the light source unit, a wavelength selecting unit that is connected to the dividing unit and that selects light having a predetermined wavelength from a range in which the output spectral ranges overlap, a time detecting unit that is connected to the wavelength selecting unit and that detects times at which the swept sources oscillate at the predetermined wavelength, and a wavenumber detecting unit that is connected to the dividing unit and that detects times at which the lights from the swept sources have the same wavenumber.

### TECHNICAL FIELD

The present invention relates to an optical coherence tomography apparatus and an optical coherence tomography method that use a plurality of light sources having different output wavelength ranges.

### BACKGROUND ART

Fourier domain optical coherence tomography (FD-OCT) apparatuses are known which acquire a signal of tomographic information of a measurement subject by taking a Fourier transform of an optical spectral interference signal. In an FD-OCT apparatus, light emitted from a light source is divided into two or more components, one of which is used as reference light and another of which is used as illuminating light with which an analyte is illuminated.

Scattered light or reflected light returns from the analyte that has been illuminated with the illuminating light, and an optical spectral interference signal based on the returning light and the reference light is acquired. The interference signal is plotted on a wavenumber space axis, and oscillates along the wavenumber space axis in accordance with the difference between an optical path length of the reference light and that of the measurement light. Accordingly, a tomographic information signal having a peak in accordance with the difference in optical path length can be obtained by taking a Fourier transform of the acquired optical spectral interference signal.

Recently, swept source optical coherence tomography (SS-OCT) apparatuses including swept sources have been attracting attention as an example of FD-OCT apparatuses.

An SS-OCT apparatus acquires an optical spectral interference signal expanded over the time axis by using a swept source which outputs light with a wavelength that varies with time. Accordingly, differential detection can be achieved. In addition, an optical spectral interference signal can be obtained which is not limited by the number of elements of a line sensor that is required in a spectral domain optical coherence tomography (OCT) apparatus, which is another example of an FD-OCT apparatus.

The intensity of the optical spectral interference signal is proportional to the product of the intensity of the reference light and the intensity of the light returning from the measurement subject. Therefore, even when the light returning from the measurement subject is attenuated by absorption, scattering, or transmission thereof, a tomographic information signal can be obtained with high sensitivity by causing the returning light to interfere with high-intensity reference light.

The tomographic information signal, which is obtained by taking a Fourier transform of the optical spectral interference signal, is the convolution of a sine-wave Fourier transform signal having a frequency corresponding to the difference in optical path length and the result of Fourier transform of a spectral shape. Therefore, the resolution (ability to display layers separately) of the tomographic information signal in the depth direction increases as the spectral range increases.

The spectral range is generally determined by a gain band of a gain medium included in the light source. Therefore, the resolution of the tomographic information in the depth direction is determined by the gain band.

A light source having a wide spectral range is required to obtain a tomographic information signal having a high resolution in the depth direction.

Accordingly, a light source unit that combines lights emitted from a plurality of light sources having different center wavelengths and partially overlapping output spectral ranges is proposed by W. Y. Oh et al. in “Wide Tuning Range Wavelength-Swept Laser With Two Semiconductor Optical Amplifiers”, IEEE Photonics Technology Letters, Vol. 17, No. 3, March 2005, pp. 678-680 (hereinafter referred to as “NPL 1”). NPL 1 discloses a system that includes a single polygonal mirror and two semiconductor optical amplifiers and that emits light obtained by combining two types of lights emitted from the two semiconductor optical amplifiers.

The light source unit disclosed in NPL 1 simply combines the lights emitted from the light sources having different center wavelengths and partially overlapping output spectral ranges and emits the combined light. However, how to obtain a tomographic image with small noise or how to process interference signals based on the plurality of light sources, on which the present inventors have focused attention, are not discussed in NPL 1.

### CITATION LIST

### Non Patent Literature

NPL 1 W. Y. Oh et al., “Wide Tuning Range Wavelength-Swept Laser With Two Semiconductor Optical Amplifiers”, IEEE Photonics Technology Letters, Vol. 17, No. 3, March 2005, pp. 678-680

### SUMMARY OF INVENTION

The present invention provides an optical coherence tomography apparatus with which noise can be reduced and a high-definition image can be obtained.

An optical coherence tomography apparatus according to an aspect of the present invention includes a light source unit including a plurality of swept sources which each emit light with a periodically varying oscillation wavelength; an interference optical system that divides light emitted from the light source unit into illuminating light for illuminating an analyte and reference light and that causes reflected light from the analyte and the reference light to interfere with each other so that interference light is generated; a light detecting unit that detects the interference light; and a processing unit that obtains a tomographic image of the analyte on the basis of an intensity of the interference light detected by the light detecting unit. The light emitted from the light source unit includes the lights emitted from the swept sources, which have different center wavelengths and partially overlapping output spectral ranges, the lights having the respective output spectral ranges and being temporally separated from each other. The optical coherence tomography apparatus further includes a dividing unit that is connected to the light source unit and that divides the light emitted from the light source unit; a wavelength selecting unit that is connected to the dividing unit and that selects light having a predetermined wavelength from a range in which the output spectral ranges overlap; a time detecting unit that is connected to the wavelength selecting unit and that detects times at which the swept sources oscillate at the predetermined wavelength; and a wavenumber detecting unit that is connected to the dividing unit and that detects times at which the lights emitted from the swept sources have the same wavenumber.

The optical coherence tomography apparatus according to the aspect of the present invention includes a light source unit that emits light including lights emitted from the swept sources, which have different center wavelengths and partially overlapping output spectral ranges, the lights having the respective output spectral ranges and being temporally separated from each other.

The optical coherence tomography apparatus also includes the wavelength selecting unit that selects light having the predetermined wavelength from the range in which the output spectral ranges overlap, the time detecting unit that detects times at which the swept sources oscillate at the predetermined wavelength, and the wavenumber detecting unit that detects times at which the lights emitted from the swept sources have the same wavenumber.

Since the wavelength selecting unit and the time detecting unit are provided, the times at which predetermined lights are oscillated in the range in which the spectral ranges of the light sources overlap can be detected. In addition, the times at which the lights emitted from the light sources have the same wavenumber can be detected by the wavenumber detecting unit.

Accordingly, the interference signals obtained by the light detecting unit on the basis of the lights of the respective output spectral ranges emitted from the swept sources can be connected together at the times at which the lights emitted from the light sources have the same wavenumber and then processed by the processing unit. More specifically, the times at which the lights emitted from the swept sources have the same wavenumber can be accurately detected, and the interference signals can be accurately connected at the same wavenumber.

When a tomographic image of the analyte is obtained by the above-described process, the noise can be reduced. In addition, the resolution in the depth direction can be increased owing to the increase in the sweeping range, and the definition of the image can be increased accordingly.

Further features of the present invention will become apparent from the following description of exemplary embodiments with reference to the attached drawings.

### BRIEF DESCRIPTION OF DRAWINGS

FIGS. 1A and 1B are schematic diagrams illustrating an optical coherence tomography apparatus according to an embodiment of the present invention.

FIG. 2 illustrates a method for connecting interference signals by the apparatus according to the embodiment of the present invention.

FIG. 3 is a schematic diagram illustrating an optical coherence tomography apparatus according to a first embodiment of the present invention.

FIG. 4 is a schematic diagram illustrating an optical coherence tomography apparatus according to a second embodiment of the present invention.

FIG. 5 is a schematic diagram illustrating an optical coherence tomography apparatus according to a third embodiment of the present invention.

FIG. 6 shows graphs of sine waves used in numerical calculation.

FIG. 7 shows graphs of spectrum after Fourier transform obtained by numerical calculation.

### DESCRIPTION OF EMBODIMENTS

The present invention is based on findings obtained by the present inventors with regard to an optical coherence tomography apparatus (SS-OCT apparatus) including a light source unit that outputs light obtained by combining lights emitted from a plurality of swept sources having different center wavelengths and partially overlapping output spectral ranges. The findings obtained by the present inventors are as follows.

That is, different tomographic images are obtained depending on the manner in which interference signals, which are obtained by a light detecting unit on the basis of the lights of the respective spectral ranges emitted from the respective swept sources, are connected together. In addition, noise can be reduced and a high-definition tomographic image can be obtained when the interference signals based on the lights of the respective spectral ranges are connected together at times at which the lights emitted from the light sources have the same wavenumber and then processed.

These findings were obtained as a result of the following study conducted by the present inventors.

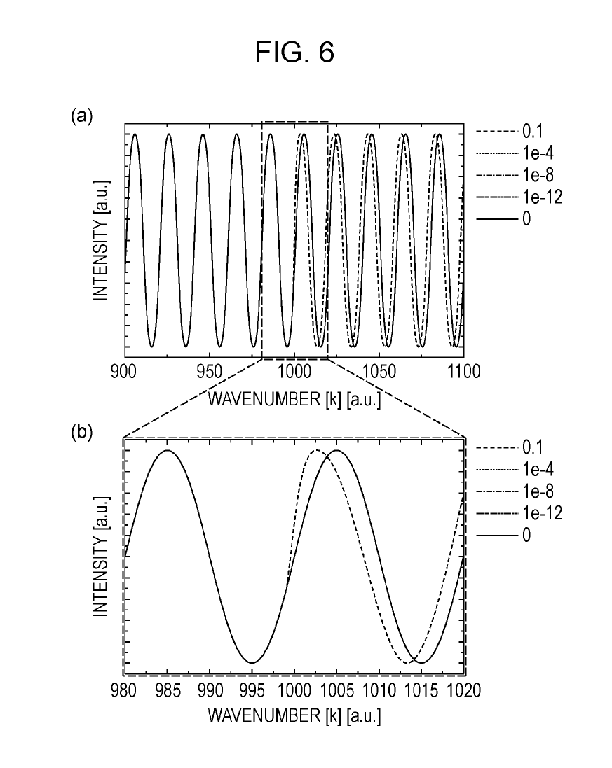

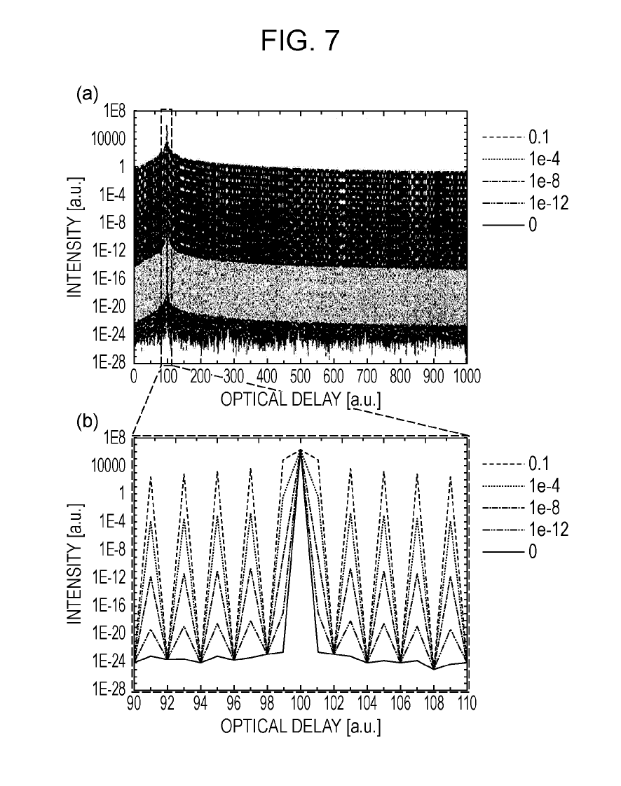

The present inventors carried out a numerical calculation regarding a tomographic image in the case where the interference signals are connected together at different wavenumbers. This will be described with reference to FIGS. 6 and 7.

In the calculation, an ideal mirror having a single reflection surface was considered. In this case, as long as the intensity of the light emitted from each swept source does not vary depending on the wavelength, the corresponding optical spectral interference signal is a constant sine wave.

Therefore, a tomographic signal, which is obtained by taking a fast Fourier transform (FFT) of the optical spectral interference signal that is a constant sine wave, has a peak at a certain single point.

In addition, the optical spectral interference signals of the lights emitted from the respective swept sources are on the same sine wave along the wavenumber axis.

Therefore, to connect the signals at different wavenumbers means to connect the signals at different phases of the sine wave.

To actually calculate this, 2,000 points were defined on a horizontal axis representing the wavenumber and it was assumed that 100 unit sine waves were generated at the 2,000 points.

The signals were divided into two regions which each include 1,000 points. Sine waves of the same frequency and having phase shifts were applied to one of the two regions. Then, the sine waves were connected together and subjected to FFT.

FIG. 6 shows graphs illustrating the manner in which the sine waves whose phase shifts are 0, 1×10−1, 1×10−4, 1×10−8, and 1×10−12 are connected at the point where the wavenumber is 1,000. Part (b) of FIG. 6 shows a graph in which the region corresponding to the wavenumber of 980 to 1020 in part (a) of FIG. 6 is enlarged.

In part (b) of FIG. 6, waves other than that in the case where the phase shift is 1×10−1 overlap the sine wave with the phase shift of 0 and cannot be observed.

FIG. 7 shows graphs of the result of Fourier transform of sine waves obtained by connecting the sine waves having phase shifts. Part (b) of FIG. 7 shows a graph in which a region of a certain optical delay in part (a) of FIG. 7 is enlarged.

It is clear from part (a) of FIG. 7 that the noise level increases and a signal-to-noise ratio (SNR) decreases as the amount of phase shift increases. In addition, it is clear from part (b) of FIG. 7 that as the amount of phase shift increases, the signal expands in a region around the peak and the resolution decreases.

Therefore, in an FD-OCT apparatus including a plurality of light sources, it is necessary to obtain the optical spectral interference signals based on the respective light sources accurately on the same wavenumber axis, and noise of a tomographic image can be reduced and definition of the tomographic image can be increased by connecting the interference signals together at the same wavenumber.

Embodiments of the present invention will now be described with reference to the drawings.

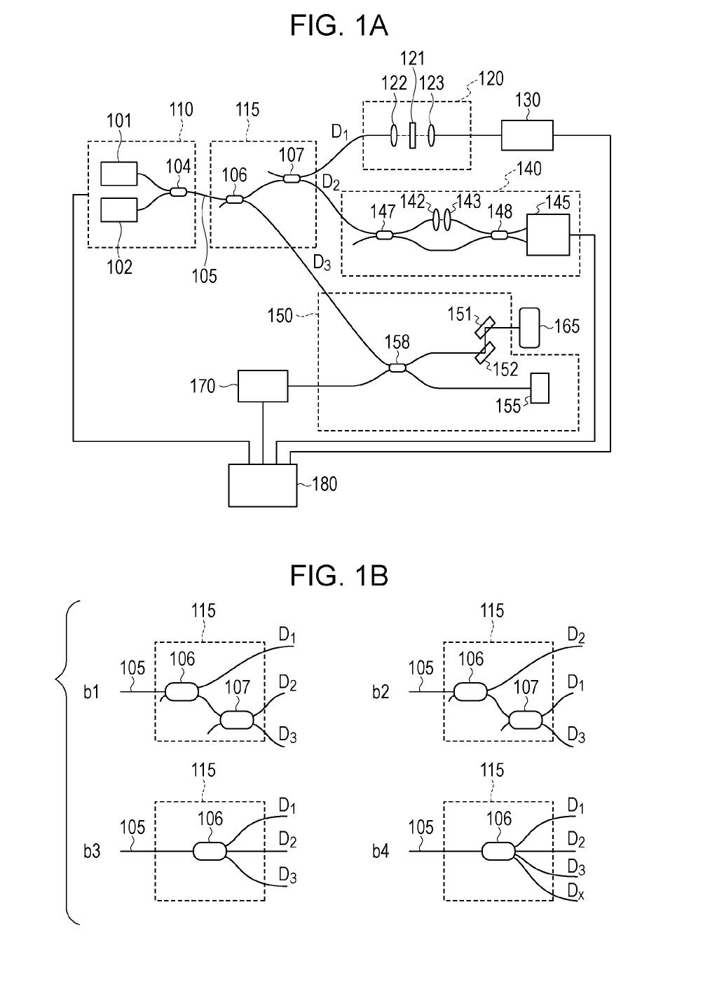

FIGS. 1A and 1B are schematic diagrams illustrating an optical coherence tomography apparatus according to an embodiment of the present invention.

FIG. 1A illustrates the overall structure of the apparatus. This apparatus basically includes a light source unit 110, a dividing unit 115 that divides light emitted from the light source unit, an interference optical system 150, a light detecting unit 170, a processing unit 180, a wavelength selecting unit 120, a time detecting unit 130, and a wavenumber detecting unit 140.

The light source unit 110, which is one of characteristic elements of the present invention, includes a plurality of swept sources 101 and 102 having different center wavelengths and partially overlapping output spectral ranges, and emits light including lights that have respective output spectral ranges and that are temporally separated from each other. An optical combiner (for example, an optical fiber coupler) 104 is provided as necessary.

The dividing unit 115 divides the light emitted from the light source unit, and includes optical couplers 106 and 107, both of which function as an optical divider, in this example.

Referring to FIG. 1A, the optical divider 106 divides light 105 that has been emitted from the light source unit through the optical combiner 104 into two lights, one of which is guided along a path D₃ connected to the interference optical system 150. The other of the two lights separated from each other by the optical divider 106 is further divided by the optical divider 107 into two lights, one of which is guided along a path D₁ connected to the wavelength selecting unit 120, and the other of which is guided along a path D₂ connected to the wavenumber detecting unit 140.

The interference optical system 150 divides the light emitted from the light source unit 110 into illuminating light for illuminating an analyte 165, which serves as a measurement subject, and reference light, and causes reflected light from the analyte 165 and the reference light to interfere with each other so that interference light is generated.

The interference optical system 150 includes an optical coupler 158, which functions as an optical combiner and an optical divider. The optical coupler 158 receives the light emitted from the light source unit 110 through a waveguide, such as an optical fiber, and divides the light into two lights, one of which is caused to illuminate the analyte 165 and the other of which is directed to a reference mirror 155. The reflected lights from the analyte 165 and the reference mirror 155 are guided to the optical coupler 158 (interference section), so that the interference light is obtained.

Here, in the present specification, the reflected light obtained by illuminating the analyte is light including not only the reflected light but also the scattered light from the analyte. Galvanometer mirrors 151 and 152 are provided to scan the analyte with the light.

FIG. 1A illustrates an example of an interference optical system. The interference optical system according to the present invention may be an interference optical system that is commonly used in an OCT apparatus. The light from the light source unit 110 is also divided by the second optical divider 107 (for example, an optical coupler) into two lights, one of which is guided to the wavelength selecting unit 120 and the other of which is guided to the wavenumber detecting unit 140.

The wavelength selecting unit 120, which is another one of the characteristic elements of the present invention, has a function of selecting light having a predetermined wavelength from a range in which the output spectral ranges of the swept sources 101 and 102 overlap.

In the example illustrated in FIG. 1, an etalon filter (Fabry-Perot etalon) 121 is used as a wavelength selecting filter, and collimator lenses 122 and 123 are provided. Alternatively, the wavelength selecting unit 120 may include, for example, a filter formed of a diffraction grating or a prism and a slit.

The time detecting unit 130 includes an optical detector, and detects the light selected by the wavelength selecting unit 120. The optical detector is connected to the processing unit 180, which includes a computer or the like, and the time at which the light has been detected is determined by the processing unit 180.

The wavenumber detecting unit 140, which is another one of the characteristic elements of the present invention, may include an interferometer. Specifically, the wavenumber detecting unit 140 may include, for example, a Michelson interferometer, a Fizeau interferometer, or a Mach-Zehnder interferometer, and these interferometers may be used as a wavenumber clock interferometer. Reference numerals 147 and 148 denote optical fiber couplers, and 142 and 143 denote collimator lenses. Reference numeral 145 denotes a differential optical detector. The optical detector 145 is connected to the processing unit 180, and the time at which the light has been detected is determined by the processing unit.

FIG. 1B illustrates modifications of the optical dividing unit 115 illustrated in FIG. 1A.

In FIG. 1B, b1 and b2 illustrate examples in which the light 105 emitted from the light source unit is divided into D₁ (connected to the wavelength selecting unit 120), D₂ (connected to the wavenumber detecting unit 140), and D₃ (connected to the interference optical system 150) by using two optical couplers 106 and 107. In addition, b3 and b4 illustrate examples in which an optical waveguide coupler 106 is used. As illustrated in b4, the light 105 from the light source unit is not necessarily divided into three lights, and may instead be divided into more than three lights, as indicated by Dₓ.

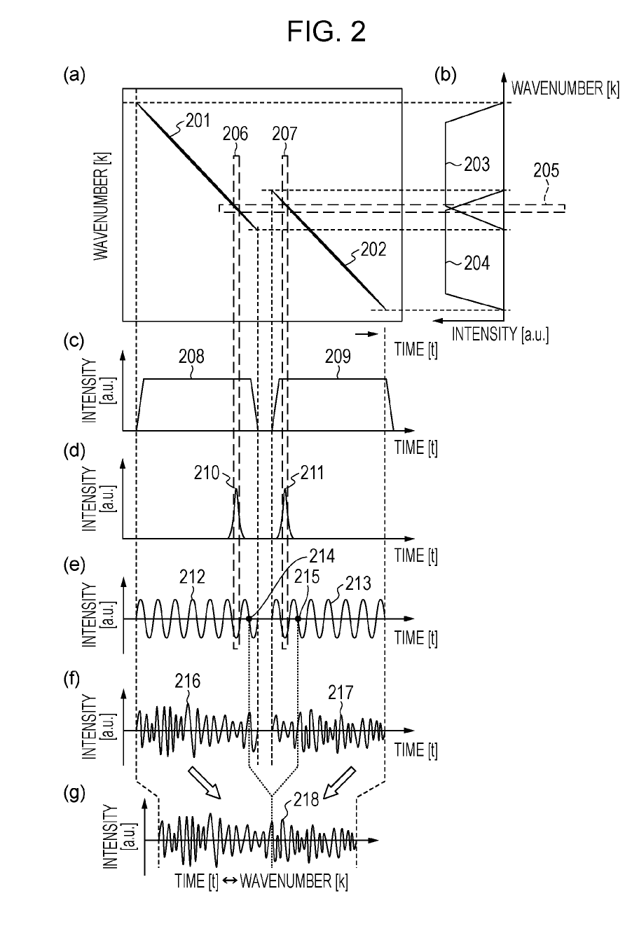

Characteristic features according to the embodiment of the present invention will now be described in detail with reference to FIGS. 1A, 1B, and 2.

### Light Source Unit

The light source unit includes a plurality of swept sources which each emit light with a periodically varying oscillation wavelength. The swept sources have different center wavelengths and partially overlapping output spectral ranges. The light source unit emits light including lights that have respective output spectral ranges and that are temporally separated from each other. The light source unit illustrated in FIG. 1 combines the lights with the optical combiner 104 and emits the combined light. However, the light source unit is not limited to this as long as the lights from the swept sources can be emitted such that the lights are temporally separated from each other. Although two swept sources are included in the apparatus illustrated in FIG. 1, the number of swept sources may be selected as appropriate depending on, for example, a sweeping range to be obtained or the use. In general, the number of swept sources is selected from 2 to 6.

Each swept source may be, for example, a light source that emits light obtained by filtering light emitted from a wide bandwidth gain medium by using a Fabry-Perot tunable filter or a spectral filter, such as a diffraction grating, a ring cavity, or a fiber bragg grating. Each swept source may instead be a light source that emits light obtained by filtering light that is spatially extended by a diffraction grating by moving a polygonal mirror or a slit-shaped mirror, or a light source that temporally expands a broadband light with a dispersing medium.

Referring to FIG. 2, parts (a) and (c) illustrate variations in the light emitted from the light source unit 110 with respect to time. Part (b) of FIG. 2 illustrates the manner in which the wavelength selecting unit 120 selects light having a predetermined wavelength from the range in which the output spectral ranges of the two swept sources overlap.

Part (d) of FIG. 2 illustrates the manner in which the light having the predetermined wavelength that has been selected is detected by the optical detector included in the time detecting unit 130 and the times at which the light has been detected are determined.

Part (e) of FIG. 2 illustrates the manner in which an interference signal is obtained by the interferometer included in the wavenumber detecting unit 140 and the times at which the lights emitted from the swept sources have the same wavenumber are determined.

Part (f) of FIG. 2 illustrates two interference signals detected by the light detecting unit 170 on the basis of the lights emitted from the two swept sources.

Part (g) of FIG. 2 illustrates the manner in which the two interference signals are connected together at the times at which the lights emitted from the light sources have the same wavenumber.

Referring to parts (a), (b), and (c) of FIG. 2, which illustrate variations in the light emitted from the light source unit 110 with respect to time, the swept source 101 outputs light 201 of a spectral range 203 in a time interval 208. The swept source 102 outputs light 202 of a spectral range 204 in a time interval 209.

### OCT Interferometer and Generation of Interference Signals

The lights 201 and 202 (part (a) of FIG. 2) that are respectively emitted from the swept sources 101 and 102 (FIG. 1A) are combined by the optical combiner 104. The combined light is emitted from the light source unit and is divided by the optical divider 106 into two lights, one of which is guided to the interference optical system 150.

The light guided to the interference optical system 150 is divided by the optical coupler 158, which functions as an optical combiner and an optical divider, into the reference light with which the reference mirror 155 is irradiated and the illuminating light with which the analyte 165 is illuminated. The optical coupler 158 causes the reflected light (including the scattered light) from the analyte 165 and the reference light to interfere with each other, so that the interference light is generated. The light detecting unit 170 detects the interference light and obtains optical spectral interference signals 216 and 217 (part (f) of FIG. 2). The optical spectral interference signals 216 and 217 (part (f) of FIG. 2) are input to the processing unit 180, which includes a personal computer (PC) or the like, via an A/D board. The interference optical system 150 may include a spatial interferometer including a beam splitter and a mirror or a fiber interferometer including an optical fiber coupler.

Detection of Times at which Predetermined Wavelength is Output

The light emitted from the light source unit 110 is divided by the optical dividers 106 and 107. One of the lights separated from each other by the optical divider 107 is guided to the wavelength filter 121, which passes light of a predetermined wavelength 205 (part (b) of FIG. 2), and the time detecting unit 130, so that optical intensity signals 210 and 211 (part (d) of FIG. 2) are obtained.

The times 206 and 207 at which the wavelength of the light emitted from the light source unit becomes equal to the predetermined oscillation wavelength 205 are determined on the basis of the optical intensity signals 210 and 211 (part (d) of FIG. 2).

The predetermined wavelength 205 is a wavelength within the range in which the spectral ranges of the swept sources overlap.

### Acquisition of Wavenumber Clock Interference Signals and Determination of Times Corresponding to the Same Wavenumber

The other of the lights separated from each other by the optical divider 107 (D₂) is guided to a wavenumber clock interferometer, which is included in the wavenumber detecting unit 140 and used to acquire wavenumber clock interference signals. Wavenumber clock interference signals 212 and 213 (part (e) of FIG. 2) are obtained by the optical detector 145, which detects the interference light obtained by the wavenumber clock interferometer (147, 142, 143, and 148). The wavenumber clock interferometer may be, for example, a Michelson interferometer, a Fizeau interferometer, or a Mach-Zehnder interferometer. The wavenumber clock interferometer may also be a spatial interferometer including a beam splitter and a mirror or a fiber interferometer including an optical fiber coupler.

The wavenumber clock interference signals 212 and 213 (part (e) of FIG. 2) that are differentially detected by a Mach-Zehnder interferometer satisfy the following expression (1).

[Math. 1]

I₍ₖ₎∝Iₒ₍ₖ₎×cos(k·Δl) (1)

Here, I₍ₖ₎ is the intensity of the wavenumber clock interference signals 212 and 213, Iₒ₍ₖ₎ is the intensity of the light emitted from the light sources, k is the wavenumber of the light emitted from the light sources, and Δl is the difference between the optical path lengths of the two arms of the wavenumber clock interferometer.

It is clear from Expression (1) that the wavenumber clock interference signals 212 and 213 have the same phase at certain wavenumber intervals in accordance with the difference Δl between the optical path lengths of the two arms of the interferometer.

Accordingly, the wavenumber clock interference signals (part (e) of FIG. 2) are input to the PC 180 via the A/D board to determine the times at which the wavenumber clock interference signals have the same phase on the basis of the times 210 and 211 (part (d) of FIG. 2) at which the wavelength of the light emitted from the light source unit becomes equal to the predetermined oscillation wavelength.

Thus, the times at which the lights emitted from the different light sources (101 and 102) at different times (208 and 209, part (c) of FIG. 2) have the same wavenumber are determined for each of the light sources.

With regard to the phase, times 214 and 215 (part (e) of FIG. 2) at which the wavenumber clock interference signals 212 and 213 becomes 0 for the first time may be detected. The wavelength of the lights oscillated by the two light sources 101 and 102 at the times 214 and 215, respectively, is close to the predetermined wavelength 205 filtered by the wavelength filter 121. Here, the wavelength close to the predetermined wavelength 205 includes the wavelength that is precisely equal to the predetermined wavelength 205.

Accordingly, the influence of intensity I of the light emitted from the light source unit can be eliminated. The times at which the wavenumber clock interference signals 212 and 213 reach the maximum or minimum value may instead be detected. In such a case, even when the offset values of the wavenumber clock interference signals 212 and 213 are not 0 owing to the wavelength dependency of the branching ratios of the optical fiber couplers or the differential shift of the differential optical detector 145, the times at which the wavenumber clock interference signals 212 and 213 have the same phase can be detected.

When the times at which the wavenumber clock interference signals become 0 or the times at which the wavenumber clock interference signals reach the maximum and minimum values are detected, data can be obtained at phase intervals of π. Therefore, the number of data points can be doubled compared to a case of other phases in which data is obtained at intervals of 2π.

The times at which the lights have the same wavenumber may be determined in consideration of the signs of derivative values of the acquired interference signals.

Conversion of Interference Signals into Signals with Regular Wavenumber Intervals by OCT Interferometer

The optical spectral interference signals are converted into data with regular wavenumber intervals on the basis of the times 214 and 215 at which the phases of the wavenumber clock interference signals 212 and 213 (part (e) of FIG. 2) are equal to a predetermined phase.

The optical spectral interference signals are converted into data with regular wavenumber intervals by inputting the wavenumber clock interference signals to an external clock channel of an A/D board and controlling data acquisition timing of the A/D board. Alternatively, the optical spectral interference signals are converted into data with regular wavenumber intervals by inputting the wavenumber clock interference signals into the A/D board as data, calculating the times at which the phases of the wavenumber clock interference signals are equal to the predetermined phase, and interpolating the optical spectral interference signals at the calculated times.

### Determination of Times Corresponding to the Same Wavenumber

If the oscillation of light is such that the precision (length) of the times 206 and 207 (part (a) of FIG. 2) corresponding to the predetermined wavelength in the range in which the spectral ranges of the swept sources overlap is greater than or equal to ½ of the period of the wavenumber clock interference signals 212 and 213 (part (e) of FIG. 2), there is a possibility that the times at which the wavenumber clock interference signals 212 and 213 become 0 for the first time will be shifted. When the precision of the times 206 and 207 that correspond to the predetermined wavelength is in the range of ½ to 1 of the period of the wavenumber clock interference signals 212 and 213, it is necessary to determine whether or not the inclinations of the wavenumber clock interference signals 212 and 213 when the wavenumber clock interference signals 212 and 213 cross 0 are the same.

Therefore, to accurately determine the times 214 and 215 at which the wavenumber clock interference signals 212 and 213 become 0 for the first time, the precision of the times 206 and 207 that correspond to the predetermined wavelength may be set so as to be smaller than ½ of the period of the wavenumber clock interference signals 212 and 213.

To increase the number of data points included in the data with regular wavenumber intervals into which the optical spectral interference signals are converted, it is necessary to increase the number of points at which the wavenumber clock interference signals 212 and 213 reach a certain phase while the swept sources perform wavelength sweeping a single time. Therefore, the difference Δl between the optical path lengths of the two arms of the interferometer included in the wavenumber detecting unit 140 is increased.

However, when the difference Δl between the optical path lengths of the two arms is increased, the period of the wavenumber clock interference signals 212 and 213 is reduced.

Therefore, it is necessary to increase the precision of the wavelength selecting filter 121 so that the precision of the times 206 and 207 corresponding to the predetermined wavelength is smaller than ½ of the period of the wavenumber clock interference signals 212 and 213.

In the case where, for example, a Fabry-Perot etalon is used, end faces of the etalon are required to have high reflectance and surface flatness. Therefore, the cost is increased.

Accordingly, to reduce the required precision of the wavelength filter 121, light obtained by further dividing the light from the light source unit that combines the lights from the swept sources may be guided to a short-Δl wavenumber clock interferometer for obtaining wavenumber clock signals with a small difference Δl between the optical path lengths of the two arms of the interferometer. Short-Δl wavenumber clock interference signals are obtained by an optical detector that detects the interference light obtained by the short-Δl wavenumber clock interferometer.

The short-Δl wavenumber clock interference signals are input to the PC 180 through the A/D board, and the times at which the short-Δl wavenumber clock interference signals have the same phase are determined on the basis of the times at which the wavelength of the light emitted from the light source unit becomes equal to the predetermined oscillation wavelength.

Accordingly, the times 214 and 215 (part (e) of FIG. 2) at which the lights emitted from the different light sources at different times have the same wavenumber can be accurately determined for each of the light sources.

### Connection of Interference Signals Obtained by OCT Interferometer

The optical spectral interference signals 216 and 217 with regular wavenumber intervals (part (f) of FIG. 2) are obtained at different times for each of the light sources. However, the times 214 and 215 (part (e) of FIG. 2) at which the lights emitted from the different light sources at different times have the same wavenumber are determined as described above.

Accordingly, the optical spectral interference signals 216 and 217 (part (f) of FIG. 2) that are detected by the optical detector on the basis of the respective swept sources are connected together by the PC 180 at the times 214 and 215 corresponding to the same wavenumber. Thus, the optical spectral interference signals obtained by the lights emitted at different times can be connected together at the same wavenumber.

### Acquisition of Tomographic Information by Fourier Transform

A tomographic signal in the direction in which the analyte is irradiated with the illuminating light is obtained by taking a Fourier transform of an optical spectral interference signal 218 (part (g) of FIG. 2), which is obtained by connecting the interference signals together at the same wavenumber, with the PC 180. The Fourier transform may be fast Fourier transform.

The precision of the times corresponding to the same wavenumber can be higher than or equal to 1/100 of the sampling intervals of the optical spectral interference signals with regular wavenumber intervals. When the precision is less than 1/100, noise of the tomographic signal obtained by connecting the optical spectral interference signals and taking a Fourier transform may be increased, and the resolution of the tomographic signal may be reduced.

### Acquisition of Tomographic Image

The illuminating direction of the illuminating light is changed by moving the galvanometer mirrors 151 and 152 included in the interference optical system 150. At each illuminating direction, the tomographic signal is obtained by the processing unit 180 by performing the above-described operation. The tomographic signals corresponding to the respective illuminating directions are arranged and subjected to reconstruction to obtain a tomographic image.

The present invention will now be explained in detail by describing concrete embodiments.

### First Embodiment

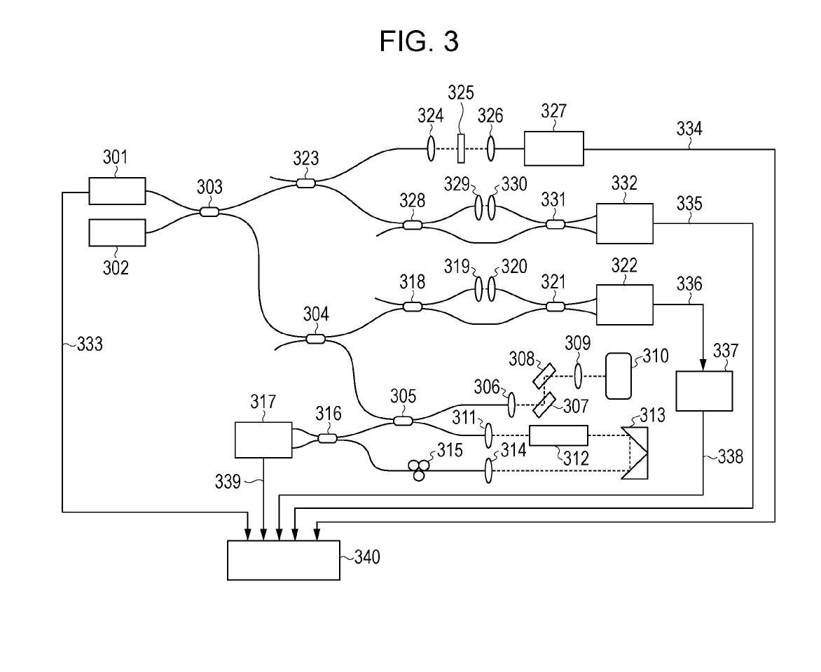

FIG. 3 is a schematic diagram illustrating an optical coherence tomography apparatus according to a first embodiment. In the apparatus according to the present embodiment, two wavenumber clock interferometers are provided to reduce the required wavelength detection accuracy.

### Light Source Unit

A light source unit emits light obtained by combining lights emitted from two swept sources 301 and 302, which each emit light with a periodically varying oscillation wavelength, with an optical fiber coupler 303.

The swept source 301 emits a synchronization signal 333 to a PC 340 included in a processing unit. The synchronization signal 333 allows an A/D board to start acquiring data in synchronization with the periodic variation of the oscillation wavelength.

Each swept source is a light source that emits light obtained by filtering light that is spatially extended by a diffraction grating by moving a slit-shaped mirror.

The output spectral ranges of the two swept sources 301 and 302 are 980 to 1035 nm and 1025 to 1080 nm, respectively, and each of the swept sources 301 and 302 sweeps the wavelength from the short wavelength side to the long wavelength side in 5 μsec. The two swept sources emit the lights with a time interval of 1 μsec.

### OCT Interferometer and Generation of Interference Signals

The light obtained by combining the lights emitted from the two swept sources 301 and 302 is emitted from the light source unit, and is divided into four lights by optical fiber couplers 303, 304, and 323.

One of the four lights that have been separated from each other is guided to an OCT interferometer.

In the OCT interferometer, an optical fiber coupler 305 divides the light guided from the light source unit into reference light and illuminating light for illuminating an analyte 310.

The reference light is guided through a dispersion compensation unit 312 and an optical delay line 313 for adjusting a wavelength dispersion and an optical path length, respectively, with respect to those of an optical path of the illuminating light with which the analyte 310 is illuminated. Then, the reference light is supplied to an optical fiber again and is guided to an optical fiber coupler 316 through an optical fiber polarization controller 315.

The illuminating light for illuminating the analyte 310 is collimated by a lens 306 and passes through an optical system for varying the illuminating direction which includes two galvanometer mirrors 307 and 308 arranged so as to be orthogonal to each other. Then, the illuminating light passes through an analyte illuminating optical system 309 that changes the profile of the illuminating light into a beam propagation profile corresponding to the analyte 310, and illuminates the analyte.

Scattered or reflected light that returns from the illuminated analyte 310 is guided to an optical fiber again, and is then guided to the optical fiber coupler 316 through the optical fiber couplers 305. The optical fiber coupler 316 causes the scattered or reflected light from the analyte 310 and the reference light to interfere with each other, so that interference light is generated.

The optical delay line 313 adjusts an optical path length of the reference light from the optical fiber coupler 305, which separates the reference light from the illuminating light, to the optical fiber coupler 316, which generates the interference light, so that the optical path length is substantially equal to an optical path length of the light that is guided to and returns from the analyte 310.

The direction of the illuminating light is controlled by the two galvanometer mirrors 307 and 308 such that the analyte is scanned along a single line in 11.3 msec. Accordingly, tomographic information signals corresponding to about 1,024 directions are obtained.

The interference light obtained by the interference optical system is detected by a differential optical detector 317. Since the differential optical detector 317 is used, noise components included in detected optical spectral interference signals owing to intensity fluctuation of the light sources can be reduced. The response speed of the differential optical detector 317 is 350 MHz.

The optical spectral interference signals are input to the PC 340 through an A/D board. The sampling speed of the A/D board is 500 MHz.

Acquisition of Wavenumber Clock Interference Signals and Data with Regular Wavenumber Intervals

Another one of the four lights that have been separated from each other is guided to a wavenumber clock interference optical system for obtaining wavenumber clock interference signals. Wavenumber clock interference signals 336 are obtained by an optical detector 322 that detects interference light obtained by the wavenumber clock interference optical system.

The wavenumber clock interference optical system is a Mach-Zehnder interferometer which includes optical fiber couplers 318 and 321. The light guided to the wavenumber clock interference optical system is divided by the optical fiber coupler 318 into two lights, one of which is guided directly to the optical fiber coupler 321. The other of the two lights is collimated by a lens 319, passes through an optical delay line for adjusting the optical path length, and is guided to the optical fiber coupler 321 through a lens 320. Accordingly, interference light is generated by the optical fiber coupler 321.

The interference light is differentially detected by the differential optical detector 322. The response speed of the differential optical detector 322 is 350 MHz.

When the optical path length of the optical delay line is 15.9 mm, the frequency of the wavenumber clock interference signals 336 is 150 MHz.

A pulse generator 337 generates signals at a level that is higher than a transistor-transistor logic (TTL) level of the A/D board at all of the times at which the wavenumber clock interference signals cross 0.

Data acquisition timing of the A/D board is controlled by inputting wavenumber clock interference signals 338, which are the signal at a level higher than the TTL level, to an external clock channel of the A/D board. Accordingly, optical spectral interference signals 339 are input to the PC 340 at regular wavenumber intervals at a clock speed of 300 MHZ.

Since each swept source performs a single sweeping process in 5 μsec, the number of data points of the optical spectral interference signal corresponding to each swept source is 1,500. The total number of data points is 3,300.

Detection of Times at which Predetermined Wavelength is Output

Another one of the four lights that have been separated from each other is used to obtain an optical intensity signal 334 and determine the times at which the wavelength of the light emitted from the light source unit becomes equal to 1,030 nm by using a Fabry-Perot etalon 325, which passes light with a wavelength of 1,030 nm, and an optical detector 327.

The thickness of the Fabry-Perot etalon 325 is set to 100 μm and the reflectance at both end faces of the Fabry-Perot etalon 325 is set to 54%, so that a wavelength selection width is set to 1 nm at a full width at half maximum.

### Determination of Times Corresponding to the Same Wavenumber

Another one of the four lights that have been separated from each other is guided to a short-optical-path-length-difference wavenumber clock interference optical system for obtaining short-optical-path-length-difference wavenumber clock interference signals. The short-optical-path-length-difference wavenumber clock interference signals are obtained by an optical detector 332 that detects interference light obtained by the short-optical-path-length-difference wavenumber clock interference optical system.

The short-optical-path-length-difference wavenumber clock interference optical system is a Mach-Zehnder interferometer including optical fiber couplers 328 and 331.

The light guided to the short-optical-path-length-difference wavenumber clock interference optical system is divided by the optical fiber coupler 328 into two lights, one of which is guided directly to the optical fiber coupler 331. The other of the two lights is guided to the optical fiber coupler 331 through an optical delay line for adjusting the optical path length. Accordingly, interference light is generated by the optical fiber coupler 331.

The interference light is differentially detected by the differential optical detector 332. The response speed of the differential optical detector 332 is 350 MHz.

Short-optical-path-length-difference wavenumber clock interference signals 335, which are obtained as a result of the differential detection, are input to the PC 340 through an A/D board.

When the optical path length of the optical delay line is 0.53 mm, the short-optical-path-length-difference wavenumber clock interference signals 335 have a period of about 2 nm. This is twice the wavelength selection width of the Fabry-Perot etalon 325, which is 1 nm, and the times at which the short-optical-path-length-difference wavenumber clock interference signals 335 cross the 0 level immediately after the times at which the wavelength was 1,030 nm can be determined as the times at which the lights emitted from the two light sources have the same wavenumber.

### Connection of Interference Signals Obtained by OCT Interferometer

The optical spectral interference signals with regular wavenumber intervals that correspond to the two light sources are obtained at different times. The times determined as described above are the times at which the lights emitted from the two different light sources have the same wavenumber. Accordingly, the optical spectral interference signals based on the lights emitted at different times can be connected together at the same wavenumber by connecting the optical spectral interference signals in accordance with the times at which the lights have the same wavenumber.

### Acquisition of Tomographic Information by Fourier Transform

A tomographic signal in the direction in which the analyte is irradiated with the illuminating light is obtained by taking a fast Fourier transform of an optical spectral interference signal obtained by connecting the above-described optical spectral interference signals together at the same wavenumber.

### Acquisition of Tomographic Image

A single tomographic signal can be obtained by a single sweeping process. The two galvanometer mirrors 307 and 308 are operated so as to scan the analyte along a single line in 11.3 msec. Thus, tomographic information signals corresponding to about 1,024 directions are obtained. A single tomographic image is obtained by arranging the tomographic information signals corresponding to the 1,024 directions.

### Second Embodiment

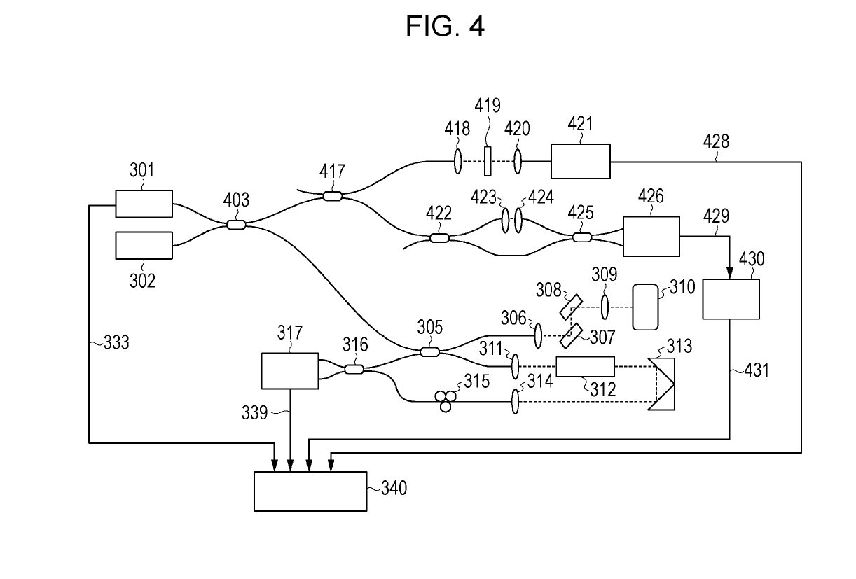

FIG. 4 is a schematic diagram illustrating an optical coherence tomography apparatus according to a second embodiment.

### Light Source Unit

A light source unit and an OCT interferometer according to the present embodiment have structures similar to those in the first embodiment. In FIG. 4, components similar to those illustrated in FIG. 3 are denoted by the same reference numerals, and explanations thereof will be omitted to avoid redundancy.

### OCT Interferometer and Generation of Interference Signals

Light obtained by combining lights emitted from two swept sources 301 and 302 is emitted from the light source unit, and is divided by an optical fiber coupler 403 into two lights. One of the two lights that have been separated from each other is guided to an OCT interferometer. Optical spectral interference signals 339 are obtained by the OCT interferometer and are input to a PC 340.

Detection of Times at which Predetermined Wavelength is Output

The other of the two lights that have been separated from each other is further divided by an optical fiber coupler 417 into two lights, one of which is used to determine the times at which the wavelength of the light emitted from the light source unit becomes equal to 1,030 nm by using a Fabry-Perot etalon 419, which passes light with a wavelength of 1,030 nm, and an optical detector 421.

The thickness of the Fabry-Perot etalon 419 is set to 100 μm and the reflectance at both end faces of the Fabry-Perot etalon 419 is set to 99%, so that a wavelength selection width is set to 0.016 nm or less at a full width at half maximum.

The reason for this is as follows. That is, since a clock speed of wavenumber clock interference signals 429 is 300 MHz as described below, data sampling is performed at wavelength intervals of 0.033 nm. To accurately detect the times at which the lights emitted from the different light sources have the same wavenumber, the precision of the times at which the wavelength is 1030 nm must be smaller than ½ of the period of the wavenumber clock interference signal.

Acquisition of Wavenumber Clock Interference Signals and Data with Regular Wavenumber Intervals

The other of the lights separated from each other by the optical fiber coupler 417 is guided to a wavenumber clock interferometer for obtaining the wavenumber clock interference signals 429. The wavenumber clock interference signals 429 are obtained by an optical detector 426 that detects interference light obtained by the wavenumber clock interferometer.

The wavenumber clock interference optical system is a Mach-Zehnder interferometer which includes optical fiber couplers 422 and 425.

The light guided to the wavenumber clock interferometer is divided by the optical fiber coupler 422 into two lights, one of which is guided directly to the optical fiber coupler 425. The other of the two lights is collimated by a lens 423, passes through an optical delay line for adjusting the optical path length, and is guided to the optical fiber coupler 425 through a lens 424. Accordingly, interference light is generated by the optical fiber coupler 425.

The interference light is differentially detected by the differential optical detector 426. The response speed of the differential optical detector 426 is 350 MHz.

When the optical path length of the optical delay line is 15.9 mm, the frequency of the wavenumber clock interference signals 429 is 150 MHz.

A pulse generator 430 generates signals 431 at a level that is higher than a TTL level of the A/D board at all of the times at which the wavenumber clock interference signals 429 cross 0.

Data acquisition timing of the A/D board is controlled by inputting the wavenumber clock interference signals 431, which are at a level higher than the TTL level, to an external clock channel of the A/D board. Accordingly, the optical spectral interference signals 339 are input to the PC 340 at regular wavenumber intervals at a clock speed of 300 MHZ.

Since each swept source performs a single sweeping process in 5 μsec, the number of data points of the optical spectral interference signal corresponding to each swept source is 1,500. The total number of data points is 3,300.

### Connection of Interference Signals Obtained by OCT Interferometer

The optical spectral interference signals with regular wavenumber intervals that correspond to two light sources 401 and 402 are obtained at different times. Data items are acquired at the same wavenumber in the range in which the spectral ranges of the two light sources overlap. The data items obtained immediately after the times at which the wavelength was 1,030 nm correspond to the same wavenumber, and the optical spectral interference signals obtained by the lights emitted at different times can be connected together at the same wavenumber by connecting the optical spectral interference signals in accordance with these data items.

### Acquisition of Tomographic Information by Fourier Transform

A tomographic signal in the direction in which the analyte is irradiated with the illuminating light is obtained by taking a fast Fourier transform of an optical spectral interference signal obtained by connecting the above-described optical spectral interference signals together at the same wavenumber.

### Acquisition of Tomographic Image

A single tomographic signal can be obtained by a single sweeping process. Two galvanometer mirrors 406 and 407 included in the OCT interferometer are operated so as to scan the analyte along a single line in 11.3 msec. Thus, tomographic information signals corresponding to about 1,024 directions are obtained. A single tomographic image is obtained by arranging the tomographic information signals corresponding to the 1,024 directions.

According to the present embodiment, the number of interferometers used to detect the wavenumber is reduced by one from that in the first embodiment.

### Third Embodiment

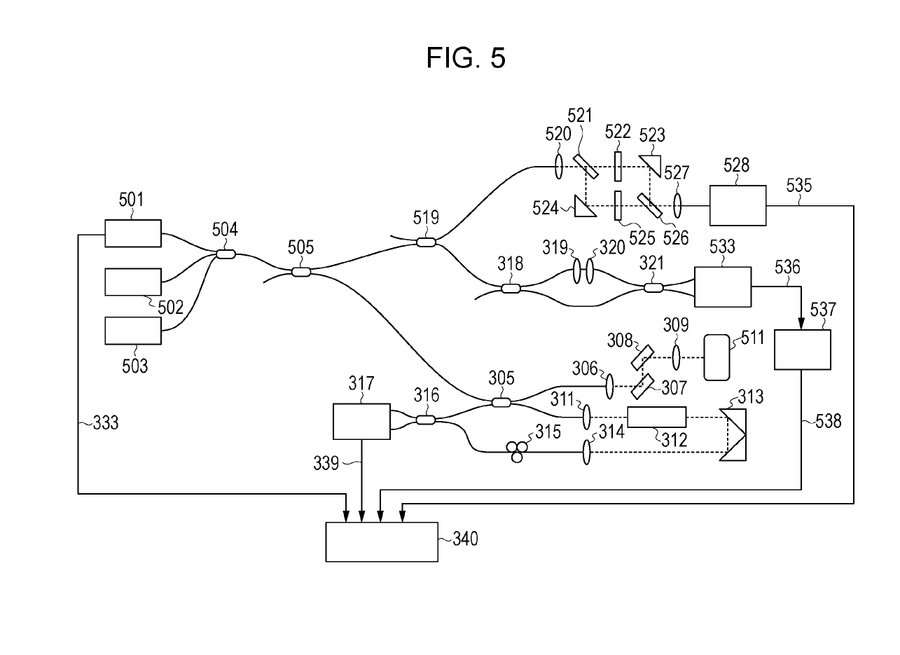

An optical coherence tomography apparatus according to a third embodiment includes a light source unit including three swept sources. The optical coherence tomography apparatus will be described with reference to FIG. 5.

### Light Source Unit

The light source unit emits light obtained by combining lights emitted from three swept sources 501, 502, and 503, which each emit light with a periodically varying oscillation wavelength, with an optical combiner 504.

Each swept source is a light source that emits light obtained by filtering light that is spatially extended by a diffraction grating by moving a slit-shaped mirror.

The output spectral ranges of the three swept sources 501, 502, and 503 are 800 to 835 nm, 825 to 860 nm, and 850 to 885 nm, respectively, and each of the swept sources sweeps the wavelength from the short wavelength side to the long wavelength side in 3 μsec. The three swept sources emit the lights with time intervals of 1 μsec.

### OCT Interferometer and Generation of Interference Signals

An OCT interferometer according to the present embodiment has a structure similar to that in the first embodiment. In FIG. 5, components similar to those illustrated in FIG. 3 are denoted by the same reference numerals, and explanations thereof will be omitted to avoid redundancy.

The light obtained by combining the lights emitted from the three swept sources is emitted from the light source unit, and is divided by an optical fiber coupler 505 into two lights. One of the two lights that have been separated from each other is guided to an OCT interferometer. Optical spectral interference signals 339 are obtained by the OCT interferometer and are input to a PC 340.

Detection of Times at which Predetermined Wavelength is Output

The other of the two lights that have been separated from each other is further divided by an optical fiber coupler 519 into two lights.

One of the lights separated from each other by the optical fiber coupler 519 is further divided by a half mirror 521. Light that passes through the half mirror 521 is guided to a Fabry-Perot etalon 522, which passes light with a wavelength of 830 nm.

Light transmitted through the Fabry-Perot etalon 522 is reflected by a mirror 523 at an angle of 90 degrees, and is guided to a half mirror 526.

Light reflected by the half mirror 521 is reflected by a mirror 524 at an angle of 90 degrees, and is guided to a Fabry-Perot etalon 525, which passes light with a wavelength of 855 nm.

Light with a wavelength of 855 nm that has been transmitted through the Fabry-Perot etalon 525 is guided to the half mirror 526.

The transmitted lights with the wavelengths of 830 nm and 855 nm are combined together by the half mirror 526. Thus, the lights with the wavelengths of 830 nm and 855 nm emitted from the light source unit are detected by an optical detector 528.

The reflectance at both end faces of each of the Fabry-Perot etalons 522 and 525 is set to 99.2%, so that a wavelength selection width is set to 0.014 nm or less at a full width at half maximum.

The reason for this is as follows. That is, since a clock speed of wavenumber clock interference signals 536 is 300 MHz as described below, data sampling is performed at wavelength intervals of 0.028 nm. To accurately detect the times at which the lights emitted from the different light sources have the same wavenumber, the precision of the times at which the wavelength is 830 nm and 855 nm must be smaller than ½ of the period of the wavenumber clock interference signal.

Acquisition of Wavenumber Clock Interference Signals and Data with Regular Wavenumber Intervals

The other of the lights separated from each other by the optical fiber coupler 519 is guided to a wavenumber clock interferometer for obtaining the wavenumber clock interference signals 536. The wavenumber clock interference signals 536 are obtained by an optical detector 533 that detects interference light obtained by the wavenumber clock interferometer.

The wavenumber clock interference optical system has a structure similar to that in the first embodiment. However, the optical path length of the optical delay line is set to 12.5 mm, and the frequency of the wavenumber clock interference signals is set to 150 MHz.

A pulse generator 537 generates signals 538 at a level that is higher than a TTL level of the A/D board at all of the times at which the wavenumber clock interference signals 536 cross 0.

Data acquisition timing of the A/D board is controlled by inputting the wavenumber clock interference signals 538, which are at a level higher than the TTL level, to an external clock channel of the A/D board. Accordingly, the optical spectral interference signals 339 are input to the PC 340 at regular wavenumber intervals at a clock speed of 300 MHZ.

Since each swept source performs a single sweeping process in 3 μsec, the number of data points of the optical spectral interference signal corresponding to each swept source is 900. The total number of data points is 3,300.

### Connection of Interference Signals Obtained by OCT Interferometer

The optical spectral interference signals with regular wavenumber intervals that correspond to the three light sources are obtained at different times. Data items are acquired at the same wavenumber in the range in which the spectral ranges of two light sources overlap.

The data items obtained immediately after the times at which the wavelength was 830 nm and 855 nm correspond to the same wavenumber, and the optical spectral interference signals obtained by the lights emitted at different times can be connected together at the same wavenumber by connecting the optical spectral interference signals in accordance with these data items.

### Acquisition of Tomographic Information by Fourier Transform

A tomographic signal in the direction in which an analyte 511 is irradiated with the illuminating light is obtained by taking a fast Fourier transform of an optical spectral interference signal obtained by connecting the above-described optical spectral interference signals together at the same wavenumber.

### Acquisition of Tomographic Image

A single tomographic signal can be obtained by a single sweeping process. The two galvanometer mirrors are operated so as to scan the analyte along a single line in 11.3 msec. Thus, tomographic information signals corresponding to about 1,024 directions are obtained. A single tomographic image is obtained by arranging the tomographic information signals corresponding to the 1,024 directions.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-086533, filed Apr. 5, 2012, which is hereby incorporated by reference herein in its entirety.

### REFERENCE SIGNS LIST

101, 102 swept source
110 light source unit
115 dividing unit
120 wavelength selecting unit
130 time detecting unit
140 wavenumber detecting unit
150 interference optical system
170 light detecting unit

1. An optical coherence tomography apparatus comprising:
a light source unit including a plurality of swept sources which each emit light with a periodically varying oscillation wavelength;
an interference optical system that divides light emitted from the light source unit into illuminating light for illuminating an analyte and reference light and that causes reflected light from the analyte and the reference light to interfere with each other so that interference light is generated;
a light detecting unit that detects the interference light; and
a processing unit that obtains a tomographic image of the analyte on the basis of an intensity of the interference light detected by the light detecting unit,
wherein the light emitted from the light source unit includes the lights emitted from the swept sources, which have different center wavelengths and partially overlapping output spectral ranges, the lights having the respective output spectral ranges and being temporally separated from each other, and
wherein the optical coherence tomography apparatus further comprises:
a dividing unit that is connected to the light source unit and that divides the light emitted from the light source unit;
a wavelength selecting unit that is connected to the dividing unit and that selects light having a predetermined wavelength from a range in which the output spectral ranges overlap;
a time detecting unit that is connected to the wavelength selecting unit and that detects times at which the swept sources oscillate at the predetermined wavelength; and
a wavenumber detecting unit that is connected to the dividing unit and that detects times at which the lights emitted from the swept sources have the same wavenumber.

2. The optical coherence tomography apparatus according to claim 1, wherein the wavelength selecting unit is a wavelength selecting filter.

3. The optical coherence tomography apparatus according to claim 2, wherein the wavelength selecting filter is an etalon filter.

4. The optical coherence tomography apparatus according to claim 1, wherein the time detecting unit includes an optical detector that is connected to the wavelength selecting unit and the processing unit.

5. The optical coherence tomography apparatus according to claim 1, wherein the wavenumber detecting unit includes an interferometer and the processing unit.

6. The optical coherence tomography apparatus according to claim 5, wherein the interferometer is one of a Michelson interferometer, a Fizeau interferometer, and a Mach-Zehnder interferometer.

7. The optical coherence tomography apparatus according to claim 6, wherein the interferometer is a wavenumber clock interferometer.

8. The optical coherence tomography apparatus according to claim 7, wherein the wavenumber clock interferometer includes a pulse generator.

9. The optical coherence tomography apparatus according to claim 1, wherein the times detected by the wavenumber detecting unit are times at which the lights that are emitted from the swept sources and that have wavelengths close to the predetermined wavelength have the same wavenumber.

10. The optical coherence tomography apparatus according to claim 1, wherein the light source unit includes a combiner that combines the lights emitted from the swept sources.

11. The optical coherence tomography apparatus according to claim 1, wherein the wavenumber detecting unit detects the times corresponding to the same wavenumber on the basis of the times at which the swept sources oscillate at the predetermined wavelength and which are detected by the time detecting unit, and the processing unit performs processing by connecting interference signals at the times corresponding to the same wavenumber, the interference signals being obtained by the light detecting unit on the basis of the lights having the respective output spectral ranges.

12. An optical coherence tomography apparatus comprising:
a light source unit including a plurality of swept sources which each emit light with a periodically varying oscillation wavelength;
an interference optical system that divides light emitted from the light source unit into illuminating light for illuminating an analyte and reference light and that causes reflected light from the analyte and the reference light to interfere with each other so that interference light is generated;
a light detecting unit that detects the interference light; and
a processing unit that obtains a tomographic image of the analyte on the basis of an intensity of the interference light detected by the light detecting unit,
wherein the light emitted from the light source unit includes the lights emitted from the swept sources, which have different center wavelengths and partially overlapping output spectral ranges, the lights having the respective output spectral ranges and being temporally separated from each other, and
wherein the optical coherence tomography apparatus further comprises:
a dividing unit that is connected to the light source unit and that divides the light emitted from the light source unit;
a wavelength selecting filter that is connected to the dividing unit and that selects light having a predetermined wavelength from a range in which the output spectral ranges overlap;
a time detecting unit that is connected to the wavelength selecting filter and that detects times at which the swept sources oscillate at the predetermined wavelength; and
a wavenumber detecting unit that includes a Mach-Zehnder interferometer, that is connected to the dividing unit, and that detects times at which the lights emitted from the swept sources have the same wavenumber.

13. An optical coherence tomography method that obtains a tomographic image of an analyte by dividing light emitted from a light source unit, which includes a plurality of swept sources which each emit light with a periodically varying oscillation wavelength, into illuminating light for illuminating the analyte and reference light, and then performing processing on the basis of interference signals obtained by detecting interference light of reflected light from the analyte and the reference light,
wherein the light emitted from the light source unit includes the lights emitted from the swept sources, which have different center wavelengths and partially overlapping output spectral ranges, the lights having the respective output spectral ranges and being temporally separated from each other, and
wherein the optical coherence tomography method comprises:
selecting light having a predetermined wavelength from a range in which the output spectral ranges overlap;
detecting times at which the swept sources oscillate at the predetermined wavelength;
detecting times at which the lights emitted from the swept sources and that have wavelengths close to the predetermined wavelength have the same wavenumber; and
performing the processing by connecting the interference signals at the times at which the lights have the same wavenumber, the interference signals being obtained on the basis of the lights having the respective output spectral ranges.

14. The optical coherence tomography method according to claim 13, wherein the times at which the lights have the same wavenumber are detected by using an interferometer other than an optical system that is connected to the light source unit and that generates the interference light of the reflected light and the reference light.

15. The optical coherence tomography method according to claim 14, wherein the times at which the lights have the same wavenumber are detected by detecting the times at which the interference signals obtained by the interferometer become equal to 0.

16. The optical coherence tomography method according to claim 14, wherein the times at which the lights have the same wavenumber are detected in consideration of signs of derivative values of the interference signals obtained by the interferometer.
